(19) United States
(12) Patent Application Publication
(10) Pub. No.: US 2026/0293887 A1
(43) Pub. Date: Oct. 1, 2026

(54) STRIP FOR RELEASING AN ANTIPARASITIC COMPOSITION TO BEES TO CONTROL PARASITIC INFECTIONS IN BEEHIVES

(71) Applicant: LABORATORIOS CALIER, S. A., LES FRANQUESES DEL VALLÈS (ES)

(72) Inventors: ANA AZNAR SANGUESA, LES FRANQUESES DEL VALLÈS (ES); ALBERT LLORCA SAGRERA, LES FRANQUESES DEL VALLÈS (ES); XÈNIA MERCADER I PUNTONET, LES FRANQUESES DEL VALLÈS (ES)

(21) Appl. No.: 19/478,031

(22) PCT Filed: Apr. 25, 2024
(86) PCT No.: PCT/EP2024/061440

§ 371 Date: Oct. 23, 2025

(30) Foreign Application Priority Data
Apr. 26, 2023 (EP) 23382384.8

(51) Int. Cl. A01N 25/34; A01K 51/00; A01N 25/02; A01N 25/10; A01N 31/02; A01N 31/08; A01N 43/54; A01N 43/56; A01P 7/02

(52) U.S. Cl. CPC A01N 25/34; A01K 51/00; A01N 25/02; A01N 25/10; A01N 31/02; A01N 31/08; A01N 43/54; A01N 43/56; A01P 7/02

(57) ABSTRACT

A strip for releasing an antiparasitic composition to bees to control Varroa in beehives. The strip has a surface to be impregnated with an antiparasitic composition having through openings for receiving the substance having a first portion and a second portion for the substance and an intermediate portion between and narrower than the first and second portions. A cross-section of the interior of the through openings includes walls sloped at an angle to each other. The strip can be used in a ready to use product and in a veterinary antiparasitic composition for the treatment or prevention of a parasitic infection in a beehive.

### CROSS-REFERENCE TO RELATED APPLICATIONS

This is a National Stage application of PCT International Application PCT/EP2024/061440, filed Apr. 25, 2024, which claims the benefit of European Patent Application EP23382384.8, filed on Apr. 26, 2023, both of which are incorporated herein by reference in their entirety.

### TECHNICAL FIELD

The present disclosure refers to treatments for controlling parasites such as e.g., Varroa and Nosema in honeybees. More specifically, the present disclosure refers to a strip for releasing an antiparasitic composition to honeybees for controlling parasitic infections in beehives.

### BACKGROUND

Bees and especially honeybees play an extremely important role in the ecosystem as pollinators and producers of honey and medicinal products. It is known that considerable damage to bees in the world is caused by pathogens and parasites. Varroa mites are one of said parasites that causes a disease called Varroasis which has been found that can destroy beehives completely. Another type of parasite is Nosema, a type of spore forming fungus, responsible for nosemosis, which causes digestive disorders and may impair the ability of bees to fly.

Besides, parasitic infections have been suggested as one of the possible causes of Colony Collapse Disorder (CCD), which is a disorder affecting honeybee colonies that is characterized by sudden colony death, with a lack of healthy adult bees inside the hive, leaving queen, nurse bees, and baby bees to die without access to nectar and pollen.

Although parasitic agents have been used to kill Varroa mites or Nosema spores, antiparasitic agents have shown to be toxic for bees and also to humans even when delivered in recommended dosages. Other antiparasitic agents are simply not as effective.

Research has been shown that milder and extreme treatments lead to higher bee mortality. Long term-low dosage treatments have been found to be less effective for killing parasites. For example, Varroa is gaining resistance to miticides over time resulting in higher concentrations within beehives being required.

Faced with the devastating effect of Varroa mites and Nosema spores, different formulations have been proposed. One example is oxalic acid (OA) which has been found to be highly effective as acaricide against Varroa. Known methods for applying oxalic acid to the beehives include dripping or sublimation. In the dripping method, the beekeepers have to prepare first a sugar solution containing a desired concentration of oxalic acid and then use it within 24 hours of its preparation. In the sublimation method, a special sublimation apparatus is needed. In both cases, beekeepers have to manipulate oxalic acid or are exposed to oxalic acid vapors with the consequent safety risks involved, given the caustic effects of oxalic acid on the eyes, skin, and respiratory system. Further, if a wrong amount of oxalic acid is applied to the beehive the efficacy of the product may be reduced or they may be an increase in toxicity for the bees.

On the other hand, antiparasitic compositions have also been applied on strips made of different materials which are intended to be placed between frames of beehives. For example, cellulose strips have been used to deliver formulations containing oxalic acid and glycerin. Further, examples of plastic polymer strips with an active substance intended to be attached to beehives are known from WO2020161155A1. There are also known devices for releasing pesticidal vapors as the ones disclosed in WO2015071890A1 and US2018116198A1 that comprise an absorbent substrate impregnated with a pesticidal material and an impermeable membrane. The substrate has dimples forming a waffled surface acting as wells to retain the pesticidal composition.

The above prior art devices have been shown to be effective in releasing a specific formulation for treating parasites. They however have the disadvantage that the antiparasitic composition is released in a non-uniform, non-controlled manner which adversely affects the efficiency of the antiparasitic treatment.

There is thus a need for an improved way for controlling parasites in beehives which solves the problems of the prior art.

### SUMMARY

A strip for releasing a veterinary antiparasitic composition to honeybees in beehives to control parasites such as Varroa mites or Nosema spores is provided herein. The present strip has been found to effectively address said need while providing further significant advantages as it will be described herein below.

As it will be explained in more detail below, the strip disclosed herein comprises a number of through openings that can be impregnated with an antiparasitic composition. The special configuration of these through openings allows for good retention of a semi-solidified or solidified antiparasitic composition with specific characteristics adapted to the configuration of the strip. The use of the strip impregnated with the antiparasitic composition results in that the antiparasitic active agent not only does not drip into the beehive in an uncontrolled manner but is only released by contact with the bees in the beehive. Additionally, these through openings also allow a uniform distribution of the composition over the whole surface of the strip which facilitates that the bees come into contact with the composition.

A veterinary antiparasitic composition for being released to honeybees through the present strip is also described herein. The veterinary antiparasitic composition disclosed herein has been specially designed to have the adequate properties of consistency which allows its use in the strip herein disclosed. In particular, the composition comprising an antiparasitic active agent, a wax, a fatty amide, and optionally a solvent has liquid consistency at a temperature above room temperature, e.g., at about 65° C., and can be easily impregnated at this temperature onto the strip by filling the through openings provided for the reception of the composition. When the composition is cooled down to room temperature it solidifies in said through openings and remains adhered to them thanks to its semi-solid state consistency and the special structural configuration of the holes.

The combined development of the mechanical configuration of the strip and the specific characteristics of the antiparasitic composition allows providing a ready to use product which shows very good efficacy against parasites, has reduced toxicity for bees, is stable during production, storage, distribution, and manipulation, and is safe for beekeepers.

The strip is configured to be inserted between beehive frames to remain inside the beehives for a certain period of time as it will be described below. The strip has a first surface to be impregnated with the antiparasitic composition to be released to bees in a beehive. Said first surface has at least a first area with a number of through openings. The through openings are intended for receiving the antiparasitic composition therein. At least some of said through openings has an interior that defines a first portion and a second portion and an intermediate portion between and narrower than the first portion and the second portion. Once a number of strips have been placed in a beehive, the antiparasitic composition in the strips is released uniformly, impregnating the bees by contact, distributing it throughout the beehive.

A cross-section of the interior of the through openings may include walls sloped at an angle to each other such as for example of 20-30°. Said walls defining the cross-section of the interior of the through openings may be for example straight or curved or a combination of both, although many other configurations are possible.

The through openings formed in the first surface may be shaped in the form of two inverted cones. It is preferred that the through openings are defined by a hexagonal perimeter, that is, through openings are preferably hexagonal in shape when viewed from the top or the bottom. Hexagonal shape resembles natural six-sided honeycomb structures allowing to compact a large number of through openings.

An interior of at least some of said through openings may be configured such that the second portion is wider than the first portion. The substance to be released can be held suitably inside the through openings and thus applied to both surfaces of the strip. For this purpose, the second portion may be preferably covered by a peelable sheet. The peelable sheet is glued to a second surface of the strip, opposite the first surface. To that effect, adhesive may be applied to the second surface of the strip. Taking into account that the mutually opposite first and second surfaces of the strip have a similar configuration, the adhesive may be applied in particular to the first area with through openings in the second surface of the strip. In general, adhesive may be applied to at least one of the first surface and the second surface of the strip.

The peelable sheet prevents the antiparasitic composition from leaking out from the through openings as it is applied hot, allowing the antiparasitic composition to cool down until it solidifies within the through openings. Once the antiparasitic composition has been solidified, the peelable sheet is removed before placing the strip inside the beehive causing the antiparasitic composition, already solidified, to be available on both surfaces of the strip. The substance could be alternatively applied to only one surface of the strip if required.

The first surface of the strip may have a second area. A thickness of the first area of the first surface is preferably thicker than a thickness of the second area of the first surface. The second area of the first surface of the strip includes two or more spaced apart sets of weakening lines. Weakening lines allow portions of the second area of the first surface of the strip to be folded to define a hanging arrangement. The hanging arrangement is suitable for suspending the strip at different heights in a beehive frame. The hanging arrangement is sized such that the strip may be hung in frames of the most commonly used beehives, namely Langstroth and Dadant hives.

A veterinary antiparasitic composition to be released into the beehive through the above-described strip is also disclosed herein. Said veterinary antiparasitic composition comprises:
a) a therapeutically effective amount of an antiparasitic active agent;
b) a wax;
c) a fatty amide of formula (I)

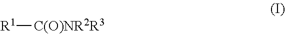

wherein R¹ is a substituted or unsubstituted (C₈-C₅₀) hydrocarbon group; R² is selected from hydrogen, an hydroxyl group, and a substituted or unsubstituted (C₈-C₅₀) hydrocarbon; and R³ is selected from hydrogen, a substituted or unsubstituted (C₈-C₅₀) hydrocarbon, and —(C₈-C₅₀)—NHC(O)—R⁴, wherein R⁴ is a substituted or unsubstituted (C₈-C₃₀) hydrocarbon group.
d) optionally a solvent;
and optionally one or more further veterinary acceptable excipients.

A further aspect of the disclosure refers to a ready to use product which comprises the strip provided with a number of through openings as defined herein, the strip being impregnated with the antiparasitic composition.

In the present disclosure, reference will be made interchangeably to the strip as defined above and to the above mentioned device comprising said strip impregnated with an antiparasitic composition.

### BRIEF DESCRIPTION OF THE DRAWINGS

Non-limiting examples of the present disclosure will be described in the following, with reference to the appended drawings, in which:

FIG. 1 is a top plan view of one example of a strip for releasing an antiparasitic composition to bees to control Varroa in beehives;

FIG. 2 is a cross-sectional view of the strip in FIG. 1; and

FIG. 3 is a detail cross-sectional view of one opening in a first area of the strip in FIGS. 1 and 2.

### DETAILED DESCRIPTION OF EXAMPLES

All terms as used herein in this application, unless otherwise stated, shall be understood in their ordinary meaning as known in the art. Other more specific definitions for certain terms as used in the present application are as set forth below and are intended to apply uniformly throughout the specification and claims unless an otherwise expressly set out definition provides a broader definition.

For the purposes of the present disclosure, any ranges given include both the lower and the upper endpoints of the range.

The term “about” or “around” as used herein refers to a range of values±10% of a specified value. For example, the expression “about 10” or “around 10” includes ±10% of 10, i.e., from 9 to 11.

The expression “therapeutically effective amount” as used herein, refers to the amount of antiparasitic active agent which, when administered to a beehive, is sufficient to kill, inhibit, reduce, slow, stabilize or control the growth of a mite population. The specific dose of the antiparasitic active agent to obtain a therapeutic benefit may vary depending on the particular circumstances of the individual case including, among others, the type of beehive and the nature and stage of a parasitic infection.

The expression “veterinary acceptable excipients” refers to components which are appropriate for use in veterinary technology for the preparation of compositions for veterinary use. Each component should be “acceptable” in the sense of being compatible with the other ingredients of the composition. When used in contact with the bees should not have excessive toxicity or other related problems or complications such as contamination of wax or honey in the beehive, commensurate with a reasonable benefit/risk ratio.

The term “antiparasitic” as used herein refers to an active agent or composition which is able to kill the mites, bacteria or fungal spores, or is able to inhibit, reduce, slow, stabilize or control the growth of a parasite population. The term “antiparasitic” comprises the terms “miticide”, “miticidal”, which are hereby equivalent to the terms “acaricide” or “acaricidal”, respectively. Non-limiting examples of parasites include “mites”, “acarids”, “bacteria” or “fungus”.

The term “parasitic infection” as used herein refers to the colonization or parasitisation of a beehive by mites, bacteria or fungal spores. The expression “treatment of a parasitic infection” means reducing, stabilizing, inhibiting, controlling or slowing the growth of a parasite population in the beehive. The expression “prevention of a parasitic infection” means avoiding that a parasitic infection is established in a beehive.

The term “ready to use product” as used herein refers to a finished product comprising a strip impregnated with the veterinary antiparasitic composition specially designed for the strip which allows its prompt and direct use without require any additional preparation or assembling steps to be performed by the user (beekeeper) before use.

The term “impregnated” as used herein means that the antiparasitic composition as defined herein is held within the through openings present in the strip.

The term “hydrocarbon” as used herein refers to a linear or branched, saturated or unsaturated hydrocarbon having a number of carbon atoms as specified herein.

For the purposes of the disclosure, the expression “room temperature” means a temperature from 20 to 25° C.

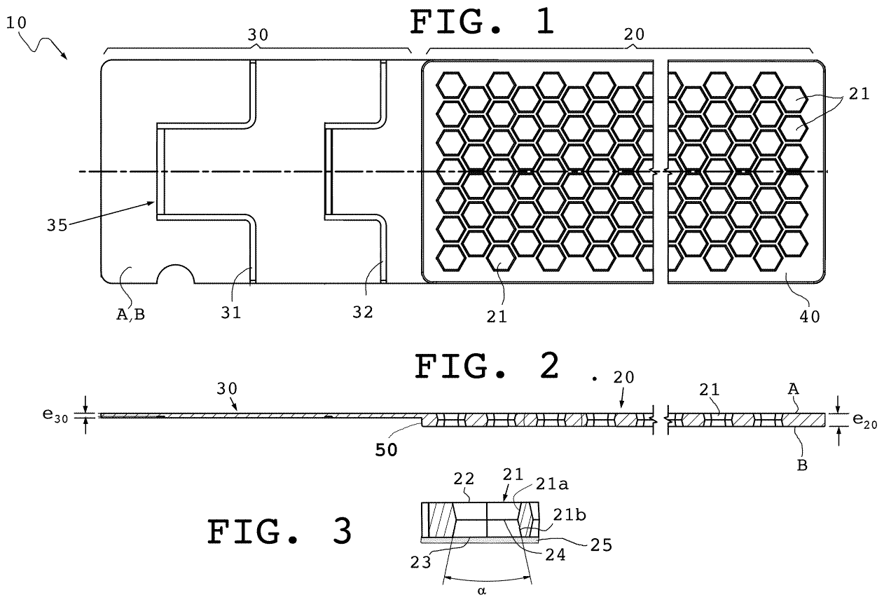

In the non-limiting example shown in FIGS. 1-3 of the drawings and disclosed herein, a strip 10 for releasing an antiparasitic composition to honeybees to control Varroa in beehives is provided.

Each strip 10 has a first surface A and a second, opposite surface B as shown in FIG. 2 of the drawings.

Referring now to FIG. 1, the first surface A of the strip 10 has at least a first area 20 where a number of through hexagonal openings 21 are formed for receiving therein the antiparasitic composition. A suitable number of strips 10 may be provided to a beehive, arranged between beehive frames. The strips 10 are left for a certain period of time during which the antiparasitic composition is uniformly released, impregnating the bees by contact, distributing it throughout the beehive.

As shown in FIG. 3 of the drawings, the cross-section of the interior of the through openings 21 comprises straight or curved walls 21a, 21b sloped at an angle to each other of 20-30° with 24° being preferred. The walls 21a, 21b thus define two inverted cones, that is, a cross-section in the shape of a double trapeze.

The above configuration results in that a first portion 22, a second portion 23, and an intermediate portion 24 between and narrower than said first and second portions 22, 23 are defined in the interior of the through openings 21.

The antiparasitic composition impregnated to the strip 10 is a viscous a liquid above 60-65° C. and solidifies into a dense paste below that temperature range. Other temperature ranges may be involved depending on the composition used for impregnating the strip 10. The antiparasitic composition is delivered hot through dosing nozzles into the through openings 21. As a result of the inclined surfaces 21a, 21b defined in the interior of the through openings 21, when the antiparasitic composition in liquid form is hot poured into the first portion 22 of the through openings 21 of the strip 10 the antiparasitic composition is retained in the intermediate portion 24 as a result of which quick solidification is promoted.

The strip 10 is presented with a peelable sheet 25 that is glued to a second surface B of the strip 10, opposite the first surface B, through an adhesive 40. The adhesive 40 is applied to the second surface of the strip B as shown in FIG. 1, and in particular in a first area 20 with through openings 21 of the second surface B of the strip.

By having the peelable sheet 25 glued to the second surface B of the strip 10 before the strip 10 is placed in the beehive frames, the second portion 23 of the through openings 21 is closed such that the antiparasitic composition that is delivered hot to the through openings 21 is held in their interior while it cools down until it solidifies. The peelable sheet 25 thus prevents the antiparasitic composition from leaking out when being hot poured into the through openings 21 of the strip 10, as stated above. Upon solidification of the formulation and prior to the application of the strip 10 inside the beehive, the peelable sheet 25 is removed causing the antiparasitic composition to be available in both surfaces A, B of the strip 10.

The first surface A of the strip 10 has a second area 30, as illustrated in FIG. 1. The second area 30 includes two spaced apart sets of weakening portions such as weakening lines 31, 32. However, in some examples, the weakening portions may be weakening holes or other suitable strip areas formed in the second area 30 This results in portions of the second area 30 of the first surface A of the strip 10 being allowed to be folded, e.g. bent up to 90° to the strip 10, to define a hanging arrangement 35. The hanging arrangement 35 allows the strip 10 to be suspended at different heights in a beehive frame preventing the strip from falling down the beehive frame. The hanging arrangement 35 is configured to fit to frames for Langstroth and Dadant hives, as well as many other hives.

It is to be noted that both mutually opposite first and second surfaces A, B of the strip 10 have a similar configuration as depicted in FIG. 1 of the drawings. In the example shown, a step portion 50 is formed in the second surface B of the strip 10 resulting from the thickness e₂₀ of the first area 20 of the first surface A being thicker than the thickness e₃₀ of the second area 30 of the first surface A as illustrated in FIG. 2.

The strip 10 is sized to fit, for example, to frames of Langstroth and Dadant hives, as well as many other types of hives. Frames are usually 24 cm high, 51.5 cm long, and 43 cm wide in Langstroth hives while frames are usually 29.6 cm high, 51.5 cm long, and 43 cm wide in Dadant hives. The strip 10 is sized to reach the bottom of a beehive. Strip thickness e₂₀, e₃₀ is selected so that the strip 10 is allowed to be easily inserted between beehive frames without hampering the passage of the bees.

In the non-limiting example shown and disclosed herein, the weight of the strip 10 is 25-29 g. The strip 10 is 310 cm long and 60 cm wide. The first area 20 of the strip 10 is 225 cm long and the second area 30 of the strip 10 is 85 cm long. The thickness e₂₀ of the first area 20 of the strip 10 is 3.5 cm, and the thickness e₃₀ of the second area 30 of the strip 10 is 1.2 cm.

Two parallel opposite sides of the hexagonal perimeter of the through openings 21 are spaced apart 6.9 cm in the first portion 22 for the antiparasitic composition in the interior of the through openings 21. In the case of the second portion23 for the antiparasitic composition, two parallel opposite sides of the hexagonal perimeter of the through openings 21 are spaced apart 8 cm. For the intermediate portion 24, two parallel opposite sides of the hexagonal perimeter of the through openings 21 are spaced apart 6.2-7.1 cm. This results in a volume of the interior of the through openings 21 of 27 cm³. Other values are possible for the present strip 10.

As mentioned above the present disclosure also refers to a veterinary antiparasitic composition suitable for use in the strip 10 as defined herein, which comprises an antiparasitic active agent, a wax, a fatty amide of formula (I), optionally a solvent, and optionally one or more further veterinary acceptable excipients.

Non-limiting examples of antiparasitic active agents that may be included in the antiparasitic composition include pyrethroids, amidine or related compounds such as abamectin (CAS RN 71751-41-2), acequinocyl (CAS RN 57960-19-7), acrinathrin (CAS RN 101007-06-1), amitraz (CAS RN 33089-61-1), bifenthrin (CAS RN 99267-18-2), bromopropylate (CAS RN18181-80-1), chlorfenapyr (CAS RN 122453-73-0), clofentezine (CAS RN 74115-24-5), coumaphos (CAS RN 56-72-4), cyflumetofen (CAS RN 400882-07-7), cymiazole (CAS RN 61676-87-7), etoxazole (CAS RN 153233-91-1), fenpropathrin (CAS RN 39515-41-8), fenpyroximate (CAS RN 134098-61-6), fenazaquin (CAS RN 120928-09-8), flumethrin (CAS RN 69770-45-2), fluvalinate (CAS RN 102851-06-9), hexythiazox (CAS RN 78587-05-0), pyridaben (CAS RN 96489-71-3), spirodiclofen (CAS RN 148477-71-8), spirotetramat (CAS RN 203313-25-1), tebufenpyrad (CAS RN 119168-77-3), and tolfenpyrad (CAS RN129558-76-5); organic acids such as formic acid, acetic acid, and oxalic acid; essential oils such as menthol, geraniol, thymol, myrcene, citral, limonene, carene, camphor, eugenol, cimofenol (carvacrol) or cineol (eucalyptol); natural oils such as lemon oil, eucalyptus oil, or neem oil; and mixtures thereof.

According to one example, optionally in combination with one or more features of the various examples described above or below, the antiparasitic active agent is selected from the group consisting of organic acids, pyrethroids, essential oils, and combinations thereof. More particularly, the antiparasitic active agent is selected from the group consisting of oxalic acid, fenazaquin, fenpyroximate, fluvalinate, and thymol, and even more particularly the antiparasitic active agent is oxalic acid, which can be in the form of oxalic acid dihydrate.

In another example, optionally in combination with one or more features of the various examples described above or below, the antiparasitic active agent has low or no insecticidal activity, i.e., has low or no toxicity against honeybees.

In another example, optionally in combination with one or more features of the various examples described above or below, the bee mortality in a beehive that has been treated with the antiparasitic composition is the same than the bee mortality in a beehive that has not been treated with the antiparasitic composition.

In another example, optionally in combination with one or more features of the various examples described above or below, the antiparasitic active agent is present in the composition in an amount from 1 to 50%, more particularly from 2 to 45%, even more particularly from 5 to 40%, and even more particular from 20 to 35% by weight with respect to the total weight of the composition. In another example, optionally in combination with one or more features of the various examples described above or below, the antiparasitic active agent is present in the composition in an amount about 1%, about 2%, about 3%, about 4%, about 5%, about 10%, about 15%, about 20%, about 25%, about 30%, about 35%, about 40%, or about 50% by weight with respect to the total weight of the composition.

In one particular example, optionally in combination with one or more features of the various examples described above or below, the antiparasitic active agent is an organic acid, particularly oxalic acid, and is present in the composition in an amount from 4 to 35%, more particularly from 20 to 30%, by weight with respect to the total weight of the composition.

In another particular example, optionally in combination with one or more features of the various examples described above or below, the antiparasitic active agent is a pyrethroid, more particularly fenazaquin or fenpyroximate, and is present in the composition in an amount from 1 to 10%, more particularly from 1 to 5%, by weight with respect to the total weight of the composition.

In another particular example, optionally in combination with one or more features of the various examples described above or below, the antiparasitic active agent is an essential oil, more particularly thymol, and is present in the composition in an amount from 4 to 35%, more particularly from 20 to 30%, by weight with respect to the total weight of the composition.

The veterinary antiparasitic composition further comprises a wax. Non-limiting examples of waxes which can be used in the context of the present disclosure include waxes of mineral or vegetable origin, and synthetic waxes, which also include chemically modified natural waxes.

According to one example, optionally in combination with one or more features of the various examples described above or below, the wax has a viscosity from 25 to 80 mPas, more particularly from 30 to 50 mPas, at 20° C.

In another example, optionally in combination with one or more features of the various examples described above or below, the wax is a (C₈-C₅₀) hydrocarbon wax. The term “(C₈-C₅₀) hydrocarbon wax” as used herein refers to a linear or branched saturated or unsaturated hydrocarbon of natural or artificial origin, which is composed solely of carbon and of hydrogen, and which contains from 8 to 50 carbon atoms. In a more particular example, the (C₈-C₅₀) hydrocarbon wax is a saturated hydrocarbon. In another more particular example, the (C₈-C₅₀) hydrocarbon wax is selected from the group consisting of petrolatum, paraffin, ozocerite, and ceresin. More particularly, the (C₈-C₅₀) hydrocarbon wax is paraffin, even more particularly liquid paraffin (CAS RN: 8042-47-5).

In another example, optionally in combination with one or more features of the various examples described above or below, the wax is a vegetable wax, more particularly selected from the groups consisting of carnauba wax and jojoba wax.

In another example, optionally in combination with one or more features of the various examples described above or below, the wax is present in the composition in an amount from 3 to 55%, more particularly from 5 to 40%, even more particularly from 10 to 35%, and even more particular from 10 to 20% by weight with respect to the total weight of the composition. In another example, optionally in combination with one or more features of the various examples described above or below, the wax is present in the composition in an amount about 3%, about 5%, about 10%, about 15%, about 20%, about 25%, about 30%, about 35%, about 40%, about 50%, or about 55%, by weight with respect to the total weight of the composition.

The veterinary antiparasitic composition further comprises a fatty amide of formula (I)

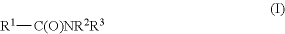

wherein R¹ is a substituted or unsubstituted (C₈-C₅₀) hydrocarbon group; R² is selected from hydrogen, an hydroxyl group, and a substituted or unsubstituted (C₈-C₅₀) hydrocarbon; and R³ is selected from hydrogen, a substituted or unsubstituted (C₈-C₅₀) hydrocarbon, and —(C₈-C₅₀)—NHC(O)—R⁴, wherein R⁴ is a substituted or unsubstituted (C₈-C₃₀) hydrocarbon group.

According to one example, optionally in combination with one or more features of the various examples described above or below, in the fatty amide of formula (I) R¹ is substituted or unsubstituted (C₈-C₅₀) hydrocarbon; R² is hydrogen or an hydroxyl group; and R³ is hydrogen. More particularly, in the fatty amide of formula (I) R¹ is an unsubstituted unsaturated (C₈-C₅₀) hydrocarbon; and R² and R³ are hydrogen.

In another example, optionally in combination with one or more features of the various examples described above or below, the fatty amide of formula (I) is selected from the group consisting of stearamide (CAS RN: 8042-47-5), oleamide (CAS RN 301-02-0), erucamide (CAS RN 112-84-5), behenamide (CAS RN 3061-75-4), lauramide (CAS RN 1120-16-7), tridecanamide (CAS RN 34778-57-9), eicosanamide (CAS RN 51360-63-5), N-hydroxyoleamide (CAS RN 10335-69-0), palmitoleamide (CAS RN 106010-22-4), and a combination thereof. More particularly, the fatty amide of formula (I) is erucamide.

In another example, optionally in combination with one or more features of the various examples described above or below, the fatty amide of formula (I) is present in the composition in an amount from 10 to 60%, more particularly from 20 to 55%, even more particularly from 25 to 45%, and even more particular about 30 to 35% by weight with respect to the total weight of the composition. In another example, optionally in combination with one or more features of the various examples described above or below, the wax is present in the composition in an amount about 10%, about 15%, about 20%, about 25%, about 30%, about 35%, about 40%, about 45%, about 50%, about 55%, or about 60% by weight with respect to the total weight of the composition.

In another example, optionally in combination with one or more features of the various examples described above or below, the weight ratio of the fatty amide of formula (I) and the wax is from 1:4 to 6:1, more particularly from 1:1 to 6:1, and even more particularly from 2:1 to 4:1. In another example, optionally in combination with one or more features of the various examples described above or below weight ratio of the fatty amide of formula (I) and the wax is about 1:4, about 1:3.5, about 1:3, about 1:2.5, about 1:2, about 1:1.5, about 1:1, about 1.5:1, about 2:1, about 2.5:1, about 3:1, about 3.5:1, about 4:1, about 4.5:1, about 5:1, about 5.5:1, or about 6:1.

The veterinary antiparasitic composition may further comprise a solvent. In one example, optionally in combination with one or more features of the various examples described above or below, the veterinary antiparasitic composition comprises a solvent. More particularly, the solvent is a polyol, a vegetable oil, or a mixture thereof.

In another example, optionally in combination with one or more features of the various examples described above or below, the veterinary antiparasitic composition comprises a solvent which is a polyol, more particularly a polyol selected from the group consisting of glycerin, propylene glycol, 1,2-butanediol, 1,3-butanediol, 1,2-pentanediol, 1,5-pentanediol, 1,2-hexanediol, 1,6-hexanediol, diglycerin, dipropylene glycol, 1,2,3-hexanetriol, 1,2,6-hexanetriol, and mixtures thereof.

Typically, the polyethylene glycol used in the antiparasitic composition has an average molecular weight (Mw) from 200 to 100000 g/mol. For example, polyethylene glycol having an average molecular weight from 200 to 8000 g/mol, more particularly from 200 to 1000 g/mol, and even more particularly from 200 to 400 g/mol may be used.

In one example, optionally in combination with one or more features of the various examples described above or below, the veterinary antiparasitic composition comprises a solvent which is polyethylene glycol.

In one example, optionally in combination with one or more features of the various exampleexamples described above or below, the veterinary antiparasitic composition comprises a solvent which is glycerin.

In another example, optionally in combination with one or more features of the various examples described above or below, the veterinary antiparasitic composition comprises a solvent which is a vegetable oil, more particularly a vegetable oil selected from the group consisting of sunflower oil, olive oil, cardamom oil, palm oil, and mixtures thereof.

In another example, optionally in combination with one or more features of the various examples described above or below, the veterinary antiparasitic composition comprises a solvent which is a mixture of a polyol and a vegetable oil, more particularly a mixture of a polyol selected from the group consisting of glycerin, propylene glycol, 1,2-butanediol, 1,3-butanediol, 1,2-pentanediol, 1,5-pentanediol, 1,2-hexanediol, 1,6-hexanediol, diglycerin, dipropylene glycol, 1,2,3-hexanetriol, 1,2,6-hexanetriol, and mixtures thereof; and a vegetable oil selected from the group consisting of sunflower oil, olive oil, cardamom oil, palm oil, and mixtures thereof; even more particularly a mixture of glycerin and sunflower oil.

In another example, optionally in combination with one or more features of the various examples described above or below, the veterinary antiparasitic composition comprises a solvent which is present in the composition in an amount from 20 to 50%, more particularly from 22 to 40%, and even more particularly from 25 to 35% by weight with respect to the total weight of the composition. In another example, optionally in combination with one or more features of the various examples described above or below, the wax is present in the composition in an amount about 20%, about 25%, about 30%, about 35%, about 40%, about 45%, about 50% by weight with respect to the total weight of the composition.

In another example, optionally in combination with one or more features of the various examples described above or below, the veterinary antiparasitic composition does not comprise a solvent.

The antiparasitic composition as defined herein may also comprise one or more further veterinary acceptable excipients. Examples of such excipients include, without limitation, viscosity modifiers, surfactants, isotonic modifiers, emulsifiers, binders, preservatives, and the like.

According to one example, optionally in combination with one or more features of the various examples described above or below, the veterinary antiparasitic composition suitable for use in the strip 10 as defined herein comprises:
a) a therapeutically effective amount of an antiparasitic active agent;
b) from 3 to 55% by weight of a wax;
c) from 10 to 60% by weight of a fatty amide of formula (I), as defined herein;
d) optionally a solvent;
and optionally one or more further veterinary acceptable excipients;
wherein the percentages are given with respect to the total weight of the composition, and wherein the weight ratio of the fatty amide of formula (I) and the wax is from 1:1 to 6:1.

According to another example, optionally in combination with one or more features of the various examples described above or below, the veterinary antiparasitic composition suitable for use in the strip 10 as defined herein comprises:
a) from 1 to 50% by weight of an antiparasitic active agent;
b) from 3 to 55% by weight of a wax;
c) from 10 to 60% by weight of a fatty amide of formula (I) as defined herein;
d) optionally a solvent;
and optionally one or more further veterinary acceptable excipients; wherein the weight percentages are expressed with respect to the total composition weight, and being the sum of all the components of the composition of 100% by weight.

More particularly, in this example, the weight ratio of the fatty amide of formula (I) and the wax is from 1:4 to 6:1.

In another example, optionally in combination with one or more features of the various examples described above or below, the veterinary antiparasitic composition suitable for use in the strip 10 as defined herein comprises:
a) from 1 to 50% by weight of an antiparasitic active agent;
b) from 3 to 55% by weight of a wax;
c) from 10 to 60% by weight of a fatty amide of formula (I) as defined herein;
d) from 20 to 50% by weight of a solvent;
and optionally one or more further veterinary acceptable excipients; wherein the weight percentages are expressed with respect to the total composition weight, and being the sum of all the components of the composition of 100% by weight.

More particularly, in this example, the weight ratio of the fatty amide of formula (I) and the wax is from 1:4 to 6:1.

In another example, optionally in combination with one or more features of the various examples described above or below, the veterinary antiparasitic composition suitable for use in the strip 10 as defined herein comprises:
a) from 4 to 35% by weight of an organic acid, more particularly oxalic acid, even more particularly oxalic acid dihydrate;
b) from 10 to 35% by weight of a wax, more particularly liquid paraffin;
c) from 20 to 55% by weight of a fatty amide of formula (I) as defined herein, more particularly erucamide;
d) from 25 to 35% by weight of a solvent, more particularly a polyol, even more particularly glycerin or polyethylene glycol;
and optionally one or more further veterinary acceptable excipients; wherein the weight percentages are expressed with respect to the total composition weight, and being the sum of all the components of the composition of 100% by weight.

More particularly, in this example, the weight ratio of the fatty amide of formula (I) and the wax is from 1:1 to 6:1.

In another example, optionally in combination with one or more features of the various examples described above or below, the veterinary antiparasitic composition suitable for use in the strip 10 as defined herein comprises:
a) from 1 to 10% by weight of a pyrethroid, more particularly fenazaquin or fenpyroximate;
b) from 10 to 35% by weight of a wax, more particularly liquid paraffin;
c) from 30 to 60% by weight of a fatty amide of formula (I) as defined herein, more particularly erucamide;
d) from 25 to 35% by weight of a solvent, a mixture of a polyol and a vegetable oil, even more particularly, a mixture of glycerin and sunflower oil;
and optionally one or more further veterinary acceptable excipients; wherein the weight percentages are expressed with respect to the total composition weight, and being the sum of all the components of the composition of 100% by weight.

More particularly, in this example, the weight ratio of the fatty amide of formula (I) and the wax is from 1:1 to 6:1.

In another example, optionally in combination with one or more features of the various examples described above or below, the veterinary antiparasitic composition suitable for use in the strip 10 as defined herein comprises:
a) from 4 to 35% by weight of an essential oil, more particularly thymol; b) from 5 to 20% by weight of a wax, more particularly liquid paraffin;
c) from 20 to 55% by weight of a fatty amide of formula (I) as defined herein, more particularly erucamide;
d) from 25 to 35% by weight of a solvent, more particularly a mixture of a polyol and a vegetable oil, even more particularly, a mixture of glycerin and sunflower oil;
and optionally one or more further veterinary acceptable excipients; wherein the weight percentages are expressed with respect to the total composition weight, and being the sum of all the components of the composition of 100% by weight.

More particularly, in this example, the weight ratio of the fatty amide of formula (I) and the wax is from 1:1 to 6:1.

It also forms part of the present disclosure a process for the preparation of the antiparasitic composition as defined herein comprising a solvent, wherein the process comprises:
i) heating the solvent or part of the solvent at a temperature from 40 to 70° C., particularly at about 50° C.,
ii) adding the antiparasitic active agent to the solvent of step i), particularly under stirring, while keeping the temperature from 40 to 70° C.;
iii) optionally adding the remaining part of the solvent;
iv) adding the wax to the mixture of step ii) or iii), particularly under stirring, and heating to a temperature from 60 to 80° C.; and
v) adding the fatty amide of formula (I) to the mixture of step iii), particularly until the fatty amide of formula (I) is dissolved.

It also forms part of the present disclosure a process for the preparation of the antiparasitic composition as defined herein comprising a solvent, wherein the process comprises:
i′) heating the solvent at a temperature from 40 to 70° C., particular at about 50° C.;
ii′) adding the antiparasitic active agent to the solvent of step i′), particularly under stirring, while keeping the temperature from 40 to 57° C.;
iii′) heating the wax, particularly under stirring, at a temperature from 60 to 80° C.;
iv′) adding a fatty amide of formula (I) to the wax of step iii′), particularly until the fatty amide of formula (I) is dissolved; and
v′) mixing the mixture of step ii′) with the mixture of step iv′).

It also forms part of the present disclosure a process for the preparation of the antiparasitic composition as defined herein in the absence of a solvent, wherein the process comprises:
i″) heating the wax at a temperature from 80 to 85° C.;
ii″) adding a fatty amide of formula (I) to the wax of step i′), particularly until the fatty amide of formula (I) is dissolved;
iii″) adding the antiparasitic active agent to the step ii′), particularly under stirring, while keeping the temperature from 95 to 105° C. until the active agent is dissolved;

A ready to use product which comprises the strip 10 provided with a number of through openings as defined above and the antiparasitic composition impregnated onto said strip 10 is described below. According to one embodiment, optionally in combination with one or more features of the various embodiments described above or below, the ready to use product comprises from 5 to 60 g, more particularly from 20 to 35 g, of antiparasitic composition impregnated onto the strip 10.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples but should be determined only by a fair reading of the claims that follow. If reference signs related to drawings are placed in parentheses in a claim, they are solely for attempting to increase the intelligibility of the claim and shall not be construed as limiting the scope of the claim.

### EXAMPLES

### Materials

For preparing the formulations the following components were used: oxalic acid dihydrate (Punjab Chemicals), thymol (Sigma-Aldrich), fenazaquin (Crysdot), fenpyroximate (Punjab Chemicals), glycerin (IOI Oleochemical), liquid paraffin (Dilube, CAS RN: 8042-47-5), erucamide (Equus UK Topco Ltd (Cargill)), Polyethylenglycol 300 (PEG300, Ineos Oxide), Polyethylenglycol 6000F (PEG6000PF, Clariant), Polyethylenglycol 8000F (PEG8000PF, Clariant), Carnauba Wax T3 flakes (Pontes Industrias de Cera), Beeswax (Sigma Aldrich), Crodabase SQ-SS-(BR) Croda/Croda), sunflower oil (Gustav Heess).

### Examples 1-14

### General Procedure I

1. Glycerin or Polyethylenglycol 300 (PEG300) were introduced in a reactor and was heated to 50° C.

2. Oxalic acid dihydrate was added to the reactor and the mixture was stirred for 20 min using propeller type agitation at a temperature 50-60° C.

3. Paraffin was added to the reactor when the oxalic acid was completely dissolved, and the mixture was stirred for 5 min using propeller type agitation.

4. Then the temperature was increased to 70-80° C. while keeping stirring the mixture.

5. Erucamide was added little by little under propeller-type agitation while keeping the temperature at 70-80° C. and the mixture is stirred until the erucamide was dissolved.

### General Procedure II

1. Glycerin or Polyethylenglycol 300 (PEG300) were introduced in a vessel and was heated to 50° C.

2. Oxalic acid was added to the reactor and the mixture was stirred for 20 min using propeller type agitation at a temperature 50-60° C.

3. Paraffin was introduced in another vessel and was heated to 85-90° C. under stirring. Erucamide was added little by little until complete dissolution.

4. The oxalic containing vessel was added to the paraffin containing vessel under stirring until obtaining complete homogenization.

5. The strips were filled with the obtained formulation.

### General Procedure III

1. Sunflower oil was introduced in a reactor and was heated to 50° C. (for thymol), 60° C. (for fenazaquin) and 70° C. (for fenpyroximate)

2. Thymol or fenazaquin or fenpyroximate was added to the reactor and the mixture was stirred for 20 min using propeller type agitation at a temperature 50-60-70° C.

3. Glycerin was added to the reactor when the thymol, fenazaquin or fenpyroximate was completely dissolved, and the mixture was stirred for 5 min using propeller type agitation.

4. Paraffin was added to the reactor, and the mixture was stirred for 5 min using propeller type agitation.

5. Then the temperature was increased to 70-80° C. while keeping stirring the mixture.

6. Erucamide was added little by little under propeller-type agitation while keeping the temperature at 70-80° C. and the mixture is stirred until the erucamide was dissolved.

### General Procedure IV

1. Paraffin wax was introduced into the reactor and heated until 80-85° C.

2. Erucamide was added until total dissolution at 80-85° C. under stirring using propeller type agitation.

3. The temperature was raised up 95-105° C. and oxalic acid was added until total dissolution under stirring using propeller type agitation

Following the above general procedures, the following compositions were obtained (the weight % of each component is given with respect to the total weight of the formulation):

| Example | 1 | 2 | 3 | 4 | 5 | 6 |
|---|---|---|---|---|---|---|
| General procedure | I | I | II | II | II | I |
| Oxalic acid | 4.4% | 10.0% | 12.5% | 10.0% | 33.3% | 20.0% |
| dihydrate (wt %) | | | | | | |
| Liquid paraffin | 27.8% | 22.2% | 21.6% | 22.2% | 11.0% | 12.0% |
| (wt %) | | | | | | |
| Glycerin (wt %) | 27.8% | 27.8% | 27.0% | 27.8% | 31.7% | 27.9% |
| PEG300 (wt %) | — | — | — | — | — | — |
| Erucamide (wt %) | 40.0% | 40.0% | 38.9% | 40.0% | 24.0% | 40.1% |
| Total (wt %) | 100% | 100% | 100% | 100% | 100% | 100% |

| Example | 7 | 8 | 9 | 10 | 11 | 12 |
|---|---|---|---|---|---|---|
| General procedure | II | II | II | II | II | IV |
| Oxalic acid | 16.7% | 16.7% | 12.5% | 10.0% | 10.0% | 16.7% |
| dihydrate (wt %) | | | | | | |
| Liquid paraffin | 11.0% | 11.0% | 10.8% | 10.0% | 10.0% | 50% |
| (wt %) | | | | | | |
| Glycerin (wt %) | 31.7% | 31.7% | 27.0% | — | — | — |
| PEG300 (wt %) | — | — | — | 30.0% | 30.0% | — |
| Erucamide (wt %) | 40.7% | 40.7% | 49.7% | 50.0% | 50.0% | 33.3% |
| Total (wt %) | 100% | 100% | 100% | 100.0% | 100.0% | 100% |

| Example | 13 | 14 | 15 | 16 | 17 | 18 | 19 |
|---|---|---|---|---|---|---|---|
| General procedure | III | III | III | III | III | III | III |
| Thymol (wt %) | 24.0% | 32.0% | — | — | — | — | — |
| Fenazaquin (wt %) | — | — | 2.0% | 3.0% | — | — | — |
| fenpyroximate | — | — | — | — | 1.0% | 2.0% | 3.0% |
| (wt %) | | | | | | | |
| Liquid paraffin | 11.0% | 11.0% | 11.0% | 11.0% | 11.0% | 11.0% | 11.0% |
| (wt %) | | | | | | | |
| Glycerin (wt %) | 6.5% | 6.5% | 6.5% | 6.5% | 6.5% | 6.5% | 6.5% |
| Sunflower oil | 25.0% | 25.0% | 25.0% | 25.0% | 25.0% | 25.0% | 25.0% |
| (wt %) | | | | | | | |
| Erucamide (wt %) | 33.5% | 25.5% | 55.5% | 54.5% | 56.5% | 55.5% | 54.5% |
| Total (wt %) | 100% | 100% | 100% | 100% | 100% | 100% | 100% |

All examples above showed a correct appearance and consistency without showing crystals or precipitation.

### COMPARATIVE EXAMPLES

The following comparative compositions were prepared as detailed below:

| | Comparative example | | | | | | | |
|---|---|---|---|---|---|---|---|---|
| | 1 | 2 | 3 | 4 | 5 | 6 | 7 | 8 |
| Oxalic acid | 4.4% | 10.0% | 33.3% | 4.4% | 4.4% | 10.0% | 10.0% | 10.0% |
| dihydrate (wt %) | | | | | | | | |
| Liquid paraffin | 85.5% | 50.0% | 50.0% | — | — | — | 45.0% | 10.0% |
| Glycerin (wt %) | — | — | — | 85.5% | 5.0% | — | — | — |
| PEG300 (wt %) | — | — | — | — | — | 20.0% | — | — |
| PEG8000 PF | — | — | — | — | — | — | 45.0% | — |
| (wt %) | | | | | | | | |
| PEG6000 PF | — | — | — | — | — | — | — | 80.0% |
| (wt %) | | | | | | | | |
| Erucamide | 10.1% | 40.0% | 16.7% | 10.1% | 90.6% | 70.0% | — | — |
| (wt %) | | | | | | | | |
| Total (wt %) | 100% | 100% | 100% | 100.0% | 100.0% | 100% | 100% | 100% |

None of these compositions gave satisfactory results.

### Comparative Example 1

Erucamide was added to paraffin and the mixture was heating under stirring at 80-90° C. The solution was allowed to cool to 85° C. and oxalic acid was added under stirring maintaining the temperature at 70-85° C. After 15 minutes the oxalic acid was not completely dissolved.

### Comparative Example 2

Erucamide was heated until completely melted at 80° C. Oxalic acid was added but did not dissolve; an agglomerate has formed. Paraffin was added under stirring. The mixture was heated to 80° C. under stirring but oxalic acid did not dissolve.

### Comparative Example 3

Paraffin was heated to 80° C. Erucamide was added little by little under magnetic stirring until erucamide was dissolved. Erucamide melted at 77° C. after 15 min. Oxalic acid was added. In order for the oxalic acid to dissolve, the mixture was heated to 100° C. A pinkish product was obtained that gave off a pungent odor.

### Comparative Example 4

Glycerin was heated under stirring. Erucamide was added melting about 78-80° C. after 15 min. At 83° C. oxalic acid was incorporated and the temperature dropped to 77° C. A wax was not formed.

### Comparative Example 5

In a water bath at 90° C., glycerin was added. Oxalic acid was incorporated, and it was completely dissolved. Erucamide was added until complete melting. The resulting product was poured onto a tray lined with aluminum. A layer of wax with acceptable consistency was obtained but it had a brittle nature and could not be bent or struck without breaking.

### Comparative Example 6

PEG 300 was heated up to 60° C. and oxalic acid was added under stirring. Erucamide was added at 80° C. little by little and the mixture was stirred for 10 min. Crystallizations appeared.

### Comparative Example 7

Paraffin was heated to 60° C. PEG8000 was added and heated until dissolution. The mixture was heated up to 90° C. but a phase separation is observed. Oxalic acid was added under stirring until dissolution. The mixture was heated up to 90° C. but presented phase separation and air bubbles.

### Comparative Example 8

PEG 6000 was heated up to 60° C. and melted. Paraffin was added under stirring. Oxalic acid was added until dissolution. However, paraffin and PEG 6000 remained immiscible.

### Strips Containing Antiparasitic Compositions

In order to test the efficacy of the strips and the miticidal composition of the disclosure, strips with through openings (holes) according to the disclosure were used. The through openings of the strip were filled with the formulation of the present disclosure directly after the preparation of the formulation (i.e., when the formulation had still liquid consistency, at about 65° C.). Mechanised dispensers (as many as through openings in the strip) were used for this purpose, which allowed maintaining the product at the correct temperature, and allowed dosing the correct amounts to each opening. For this purpose, once the formulation was produced, a volume of the formulation was transferred to a buffer tank where the temperature was maintained to keep the formulation in liquid state. The buffer tank supplied the formulation to a dose dispenser located in front of the buffer tank. The temperature was maintained under control also in all the connections used to contain or transport the formulation. An empty strip was placed below the dose dispenser. The strip was moved to the correct position and the exact quantity of formulation was dosed in any opening. This procedure was repeated for a new empty strip until all the formulation from the buffer tank was transferred to the strips.

After depositing the formulation to the through openings of the strip, the formulation was left to cool and at room temperature, the composition exhibited a semi-solid state, consistent enough to stay into the through openings on the strip. A label was sticked on the back to prevent leaking during filling and cooling down of the product.

### Clinical Trials

Strips prepared as above and containing the formulations of examples 2, 6, 8 or 12 (27.6 g of formulation in each case), were tested in clinical trials in hives infested by Varroa destructor. Two different studies were carried out according to the European Medicine Agency's (EMA) Guideline on veterinary medicinal products controlling Varroa destructor parasitosis in bees (EMA/CVMP/EWP/459883/2008-Rev.1*). One study was with 2 strips placed in the hives for 6 weeks and the other was with 2 strips placed in the hives for 3 weeks, and after this, two strips were removed, and 2 new strips were placed in the hives for 3 more weeks. Trays for appropriate counting of the mites killed by treatment were used. According to the EMAs' guideline, the rate of mite mortality after treatment with the product under investigation was determined using a follow-up treatment in the treated colony itself with a chemically unrelated substance with >95% documented efficacy. The follow-up treatment was carried out shortly after treatment with the test product in order to keep the reinfestation level low. In this case, the follow-up treatment was Apitraz (Calier) with a proven efficacy of about 99%.

The efficacy of the tested formulation (i.e., % of mite reduction) was calculated by the following formula:

$$\% Mite reduction = \frac{( N ° . of mites in test group killed by treatmemt \times 100 )}{( N ° . of mites in test group killed by treatment + N ° . of mites killed in test group after follow - up treatment )}$$

The results of the clinical trials were as follows:

| | | Efficacy (%) | Efficacy (%) |
|---|---|---|---|
| | Number | after 6 weeks | after 3 + 3 weeks |
| | of hives | (2 strips/hive) | (2 strips + 2 strips/hive) |
| Example 8 | 2 | 85.5% | 93.9% |
| Example 12 | 2 | 98.3% | 85.0% |

As can be seen the formulations of the present disclosure showed very high efficacy values. By contrast, in the clinical trials analog placebo formulations without antiparasitic agent were also tested in 15 hives. After 6 weeks, it was observed that the efficacy for these placebo compositions was either very low (efficacy values in 5 hives ranging from 19.4% to 44.5%, average: 31.8%) or resulted in the death of the hive.

### Citations List

EMA's Guideline on veterinary medicinal products controlling Varroa destructor parasitosis in bees (EMA/CVMP/EWP/459883/2008-Rev.1*).

What is claimed is:

1. A strip for releasing a veterinary antiparasitic composition in beehives, the strip comprising a first surface to be impregnated with the antiparasitic composition to be released to bees in a beehive, the first surface having at least a first area with a number of through openings for receiving the antiparasitic composition therein, at least some of said through openings having an interior defining a first portion for the antiparasitic composition, a second portion for the antiparasitic composition, and an intermediate portion between and narrower than the first portion and the second portion.

2. The strip of claim 1, wherein a cross-section of the interior of the through openings includes walls sloped at an angle to each other.

3. The strip of claim 2, wherein the walls defining the cross-section of the interior of the through openings are at least one of straight and curved.

4. The strip of claim 2, wherein the walls are sloped at an angle of 20-30° to each other.

5. The strip of claim 4, wherein the walls are sloped at an angle of 24° to each other.

6. The strip of claim 2, wherein the interior of the through openings is shaped in the form of two inverted cones.

7. The strip of claim 1, wherein the second portion is wider than the first portion.

8. The strip of claim 1, wherein the first surface of the strip has a second area that includes at least two spaced apart sets of weakening lines allowing portions of the second area to be folded to define a hanging arrangement for suspending the strip at different heights in a beehive frame.

9. The strip of claim 8, wherein a thickness of the first area is thicker than a thickness of the second area.

10. The strip of claim 1, wherein the second portion is covered by a peelable sheet.

11. The strip device of claim 10, wherein the peelable sheet is glued to the first area with through openings of the strip.

12. A ready to use product for releasing a veterinary antiparasitic composition in beehives, the ready to use product comprising a strip including a first surface to be impregnated with the antiparasitic composition, the first surface having at least a first area with a number of through openings for receiving the antiparasitic composition therein, at least some of said through openings having an interior defining a first portion for the antiparasitic composition, a second portion for the antiparasitic composition, and an intermediate portion between and narrower than the first portion and the second portion.

13. The ready to use product of claim 12, wherein the antiparasitic composition comprises:
a) a therapeutically effective amount of an antiparasitic active agent;
b) a wax;
c) a fatty amide of formula (I) 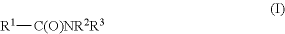
wherein R¹ is a substituted or unsubstituted (C₈-C₅₀) hydrocarbon group; R² is selected from hydrogen, an hydroxyl group, and a substituted or unsubstituted (C₈-C₅₀) hydrocarbon; and R³ is selected from hydrogen, a substituted or unsubstituted (C₈-C₅₀) hydrocarbon, and —(C₈-C₅₀)—NHC(O)—R⁴, wherein R⁴ is a substituted or unsubstituted (C₈-C₃₀) hydrocarbon group,
d) optionally a solvent;
and optionally one or more further veterinary acceptable excipients.

14. The ready to use product of claim 13, wherein the antiparasitic composition comprises from 2 to 50% by weight of the antiparasitic active agent, from 3 to 55% by weight of the wax, from 10 to 60% by weight of the fatty amide, and from 20 to 50% by weight of the solvent, wherein the percentages are given with respect to the total weight of the composition.

15. The ready to use product of claim 12, wherein the antiparasitic active agent is selected from the group consisting of an organic acid, a pyrethroid, an essential oil, and a combination thereof; the wax is selected from the group consisting of a wax of mineral or vegetable origin; in the fatty amide of formula (I) R¹ is an unsubstituted unsaturated (C₈-C₅₀) hydrocarbon; and R² and R³ are hydrogen; and the solvent is a polyol or a vegetable oil.
